(19) United States
(12) Patent Application Publication
(10) Pub. No.: US 2024/0303565 A1
(43) Pub. Date: Sep. 12, 2024

(54) SYSTEM AND METHOD FOR GOLF COURSE MANAGEMENT

(71) Applicant: NAM VAN TRAN, Ha Noi (VN)

(72) Inventor: NAM VAN TRAN, Ha Noi (VN)

(73) Assignee: NAM VAN TRAN, Ha Noi (VN)

(21) Appl. No.: 18/277,064

(22) PCT Filed: Aug. 3, 2022
(86) PCT No.: PCT/IB2022/057218

§ 371 Date: Aug. 11, 2023

(30) Foreign Application Priority Data
Aug. 16, 2021 (VN) 1-2021-05032

(51) Int. Cl. G06Q 10/0631

(52) U.S. Cl. CPC G06Q 10/06314

(57) ABSTRACT

The present invention relates to a system and a method for golf course management utilizing IoT solutions to comprehensively improve efficiency of the golf course management. The system according to the present invention comprising: the central sever for storing and processing data corresponding to operations of the golf course, the central sever allowing terminal devices capable of accessing and transceiving data with the central sever; the golf cart monitoring module is disposed on each golf cart for collecting at least the golf cart location data which is related to the real time location of the corresponding golf cart and the battery data which is related to the operating status of the golf cart battery, for sending the golf cart location data and the battery data to the central sever. Utilizing the operating golf cart locations to draw a map which includes at least the operating golf carts for displaying to the marshal of the golf course. The operating golf carts displayed on the map will be assigned the colors of green, red, or yellow due to the corresponding actual moving status of each golf cart to the predetermined moving schedule. A speaker will generate sound for reminding the golfers if they move slower than the moving schedule. The present invention also relates to the corresponding method for golf course management.

### TECHNICAL FIELD

The present invention relates to a system and a method for golf course management, and more particularly, to a system and a method for golf course management utilizing IoT solutions to comprehensively improve the efficiency of the golf course management.

### BACKGROUND

As generally known, golf is a sport in which a player may use variety of different golf clubs in a game or a match to hit a golf ball into a small hole on the golf course, called as a golf hole or a hole, so as the number of hits to make the golf ball form a starting point/teeing point to go into the golf hole, as few as possible.

Although, with said playing rule which seems to be pretty simple but golf is an interesting sport, is more and more loved and popular on over the world in general and Viet Nam in particular. The sport requires a very high precise, a golfer/golf player shall need to calculate carefully to perform to hit the golf ball into the golf hole which has a very small diameter or at least to a location where is closer to the golf hole to facilitate the next hit. This is supposed to be an interesting challenge, but not stop thereto, while a golf course is built, people often design various different challenging areas on the golf course to obstruct the players from making the golf ball goes into the golf hole. These challenging areas are generally placed in between the teeing ground (called as Tee Box) and the surrounding area of the golf hole (called as Green, is an area which is designed with green and smooth grass to facilitate for pushing the golf ball rolling into the golf hole), the teeing ground and the surrounding area of the golf hole are generally in a relatively far distance to each other, for example about 227 m, 230 to 430 m, or greater than 431 m due to the standard number of strokes (the number of hits) which is possible to make the golf ball from the tee box to go into the golf hole. The challenging areas may be in various different forms, such as rough surface areas, areas with high grass, areas with high trees, areas with sand traps, and there may have hazard areas for example a lake (if there is a golf ball is hit to fly to said hazard area, the corresponding player may be imposed with penalty points or may be called as penalty strokes). These elements make for topographic types which are very different from each other on the golf course, requiring the golfers to have to carefully calculate to perform precise hits, to ensure that the ball not to fly to challenging areas (for example, sand traps), and come to the golf hole as close as possible. In a case that the golf ball fly to challenging areas, the players need to find a manner to take the golf ball out to a favorable area as quick as possible. It can be seen that, the golfer shall need to perform variety of different hitting techniques to make the golf ball from the tee box, pass through challenging areas, to the surrounding area of the golf hole, sometimes the players have to hit so as the ball is to fly as far as possible (for example, at the time of tee off), sometime they have to hit so as the ball is to fly highly, fly closely, or push to roll on the surface of the course to fall down to the golf hole, for example. To perform favorably the hitting situations corresponding to various different complex topographic areas, the golfers often use a set including plurality of different golf clubs, may be up to 14 type of different clubs or more, and this is to contribute to the golf sport become diversified, richly, and requiring for a professionalism.

A golf course is generally built on a large area of land, which may be up to a scale of several tens of hectares, such as 57 has for a golf course with standard 18 holes, for example. Golf may be played by an individual group, or played as a professional league may be up to more than 100 players who are divided into plurality of small groups. The golfers are allowable to bring and use about 14 type of golf clubs in any playing round.

In general, both playing of the individual group or playing in the professional league, there will have groups each includes three or four players to compete against each other. To complete a golf match or a golf playing round, for example with a golf course having standard 18 holes, the golfers must finish all of the 18 golf holes, anyone among them who finish all of the 18 golf holes with the smallest number of strokes (the number of hits) will be a winner. The golf holes (hole) on the golf course are substantially arranged in a round, when finishing the last hole of the players will be close to the starting place. If the golf course has a smaller number of holes, for example 9 instead of 18 golf holes, the players may be moved two rounds to finish the match. In addition, if the players want to play more they may move more than one round of a golf course with a certain number of holes, for example 2 round of the golf course with 18 holes, or 4 rounds of the golf course with 9 holes.

In overall, to finish a match or a golf playing round, the golfers have to move all the way with relatively long distance continuously pass through all of the hole areas of the golf course, and bring the entire of their personal things/items during moving. Currently, the golf courses are all equipped with golf carts used for the players, each golf cart will be assigned to a golf playing group and there is always a golf waiter (called as Caddie) to go along with the golf cart to provide on-site services for the golf playing group, including both guiding and ordering for foods. Although, each golf playing group usually a caddie going together with the group, however, to finish one golf playing round, it takes up to 4 hours, and on over a relatively large area of the golf course, a distance between a golfer and the operating center may be up to 5 or 7 km. This makes managers/central operators (called as Marshal) are difficult to capture the reality of what is happening from the golf cart and the golfers on the course, forcing them to take regularly checking, monitoring measures, which is inconvenient to both golf staffs and golfers. The outdoor working tasks with a lot of walking, may cause the loss of labor power, prolonging the operational time, difficulty for operations or may lead to incorrect operations, reducing in efficiency (for example, when it rains). As a result, it leads to an actual situation that needs many staffs for operating the golf course, and it seems to raise the managing cost.

For connecting between the operating center and the golf cart, a currently popular manner is to use walkie talkie communication, phone call, message, the necessary or important information will be saved by the manual note manner using paper books/notebooks. This is easily to lead to a delay or interrupted status of information, making the operational time increased, reducing the level of the professional service, and may cause a longer waiting time over all the procedures as for golfers and players who book for playing golf.

An issue is also very interested that is the executive management of the golf course which is currently executed by monitoring and reminding the golfer to be complied to the regulations of the golf course. The compliance of the regulations on the golf course not only contributes to promote the golf culture, reputation of the golf course, but may also further increase the performance and the revenue for the golf course. Although, the golf courses generally lack of technical means for a prompt reminder whenever the golfers violate the regulations of the golf course.

An example of a regulation violation of the golf course is that the golfers violate the regulation on the playing time, they play slowly or make it over time without moving to the next golf hole. This may lead to the situation that the next players group have to wait longer for the hole is available at this location, may make a discomfort. Moreover, the slow play or the over time making without moving as mentioned may issue a situation in which the status of the golf holes not in well control to arrange for new golf playing groups, i.e. there will be less in the number of the playing groups to be arranged than that of the realistic possibility, and result in reducing the performance and the revenue for the golf course.

Hence, there is a need for a solution for improving efficiency of the golf course management utilizing IoT solutions, which not only favorably solves the above problems but may also provide an automated supporting platform, which is efficient and convenient for the golf courses and their customers who are golfers.

### SUMMARY

An object of the present invention is to provide a system and a method for golf course management, may overcome one or more of the above-mentioned problems.

Another object of the present invention is to provide a system and a method for golf course management utilizing IoT solutions capable to automatize the profession of the golf course management, thus enhancing the professionalism, reducing cost, and increasing revenue for the golf course.

Yet another object of the present invention is to provide a system and a method for golf course management, capable to determine the real time location of the golf carts and the expectation of the movement of the golf carts, and based on that to provide the determining and monitoring manners related to the information of whether the golfers play fast or slow, the expected information of the available golf holes, etc., this is therefore capable to provide more efficiently in the golf course operations.

Still, another object of the present invention is to provide a system and a method for golf course management, capable to provide the users a platform which, for example, is capable to determine the situation of the golf course (such as there is an available hole or not), conveniently books a game via the internet.

Various objects to be achieved by the present invention are not limited to the aforementioned objects, and those skilled in the art to which the disclosure pertains may clearly understand other objects from the following descriptions.

To achieve one or more above objects, according to an aspect, the present invention provides a system for golf course management comprising:
a central sever for storing and processing data corresponding to operations of the golf course, the central sever allowing terminal devices capable of accessing and transceiving data with the central sever;
a golf cart monitoring module is disposed on each golf cart for collecting at least the golf cart location data which is related to the real time location of the corresponding golf cart and the battery data which is related to the operating status of the golf cart battery, for sending the golf cart location data and the battery data to the central sever;
wherein:
the golf cart monitoring module including a golf cart positioning unit, a central sever communication unit, a golfer communication unit, a control and golf cart battery protection unit, and a storage,
the golf cart positioning unit for determining the real time location of the corresponding golf cart via GPS,
the control and golf cart battery protection unit for controlling and determining the operating status of the golf cart battery,
the central sever communication unit for communicating with the central sever via the radio communication,
the storage for storing at least pre-recorded audio files, temporarily storing data sending/receiving to/from the central sever if the golf cart moving within a region with weak 3G/4G signals,
the golfer communication unit including at least a light and/or sound generator for generating light or sound from the pre-recorded audio files stored in the storage whenever there is a request for generating light or sound sent from the central sever;
golf course management terminal devices are capable of accessing and transceiving data to the central sever for receiving at least the golf cart location data among the operating golf carts which are in the status of use for carrying the golfers, and utilizing the operating golf cart locations to draw a map which includes at least the operating golf carts for displaying to the marshal,
wherein, the operating golf carts displayed on the map on the map will be assigned to the first, second, or third colors due to the corresponding actual moving status of each golf cart compared to the predetermined moving schedule of the golf cart,
an operating golf cart displayed on the map is assigned to a first color if the corresponding golf cart moves faster than the predetermined moving schedule,
an operating golf cart displayed on the map is assigned to a second color if the corresponding golf cart moves as appropriate as the predetermined moving schedule,
an operating golf cart displayed on the map is assigned to a third color if the corresponding golf cart moves slower than the predetermined moving schedule;
   the central sever sending a request for generating light or sound to the golf cart monitoring module at least when the corresponding operating golf cart moves slower than the predetermined moving schedule for generating signal light or reminder sound via the light and/or sound generator, wherein the reminder sound is pre-recorded in an audio file stored in the storage of the golf cart monitoring module.

Preferably, when the golf cart is determined as moving slower than the predetermined moving schedule,
the golf cart monitoring module will generate a warning with a signal light for reminding the golfers regarding to a violation beyond the scheduled time,
if the golfer continues to violate then the golf cart monitoring module will generate a warning with an audio for reminding the golfers regarding to the continuing violation,
if the golfers ignore one or several said warnings with the signal light or the audio, and continue to violate, a violation report will be created and sent to the golf course management terminal devices.

According to an embodiment, the golf cart monitoring module is configured to allow the golf course management terminal devices capable to communicate to the golf cart monitoring module, directly or via the central sever.

According to an embodiment, the status of the golf holes capable to determine based on the locations of the operating golf carts on the map, if a golf hole is without a presence of any operating golf cart being at the location of said golf hole then the golf hole is considered as an available golf hole, if a golf hole is with a presence of an operating golf cart being at the location of said golf hole then the golf hole is considered as a busy golf hole,
wherein an estimated time duration for each busy golf hole becomes an available golf hole and each available golf hole becomes a busy golf hole, is capable to determine based on the predetermined moving schedule of the operating golf cart being at the location of said golf hole or be going to move to the location of said golf hole,
based on the status of golf holes, the assignment of the golf hole for new players on the golf course is capable to perform via the golf course management terminal devices.

Preferably, said map further displaying non-operating golf carts which is assigned to a fourth color, corresponding to the golf carts in the status that not assigning for players to use, based on the non-operating golf cart information, the assignment of the golf cart for new players on the golf course is capable to perform via the golf course management terminal devices.

According to an embodiment, the first color is green, the second color is yellow, the third color is red, and the fourth color is grey.

According to an embodiment, the above mentioned system further including caddie terminal devices capable of accessing and transceiving data with the central sever for sending at least the confirmation information of the golf cart start operation, the confirmation information of the golf cart stop operation, and the additional services information, the foods ordering information, or the same information to the central sever.

According to an embodiment, the above mentioned system further including user terminal devices capable of accessing with the central sever for booking a game, seeing information related to the golf course, or the same information.

According to an embodiment, the central sever further configured to score the golfers by comparing the moving time of the corresponding golf cart to the predetermined moving schedule, and plus the accumulative scores for golfers who have the corresponding golf carts moving faster than the predetermined moving schedule.

Preferably, the central sever utilizing the operating time history of the golf cart, when the planning time period is passed, a message will be sent automatically to the terminal device of the golf cart managing staff, for reminding a periodical maintenance schedule.

Preferably, the central sever utilizing the operating time history and the operating status of the golf cart battery, for sending a message to the corresponding staff, suggesting for a maintenance or an error correction, or replacing a new golf cart battery.

Preferably, the golf cart monitoring module capable of using electric power source supplied from the golf cart battery and integrated to a golf cart battery unit for facilitating during an installation or a replacement.

According to another aspect, the present invention provides a method for golf course management comprising the steps of:
storing and processing, by the central sever, data corresponding to operations of the golf course, wherein the central sever allowing terminal devices capable of accessing and transceiving data with the central sever;
collecting, by the golf cart monitoring module disposed on each golf cart, at least the golf cart location data which is related to the real time location of the corresponding golf cart and the battery data which is related to the operating status of the golf cart battery, and sending the golf cart location data and the battery data to the central sever;
wherein:
the golf cart monitoring module including a golf cart positioning unit, a central sever communication unit, a golfer communication unit, a control and golf cart battery protection unit, and a storage,
the golf cart positioning unit for determining the real time location of the corresponding golf cart via GPS,
the control and golf cart battery protection unit for controlling and determining the operating status of the golf cart battery,
the central sever communication unit for communicating with the central sever via the radio communication,
the storage for storing at least pre-recorded audio files,
the golfer communication unit including at least light and/or sound generator for generating light or sound from pre-recorded audio files stored in the storage whenever there is a request for generating light or sound sent from the central sever;
receiving, by the golf course management terminal devices which are capable of accessing and transceiving data with the central sever, at least the golf cart location data of the operating golf carts which are in the status of using for carrying the golfers, and utilizing the operating golf cart locations to draw a map which includes at least the operating golf carts for displaying to the marshal,
wherein, the operating golf carts displayed on the map will be assigned the first, second, or third colors due to the corresponding actual moving status of each golf cart to the predetermined moving schedule of the golf cart,
operating golf cart displayed on the map is assigned to a first color if the corresponding golf cart moves faster than the predetermined moving schedule,
operating golf cart displayed on the map is assigned to a second color if the corresponding golf cart moves as appropriate as the predetermined moving schedule,
operating golf cart displayed on the map is assigned to a third color if the corresponding golf cart moves slower than the predetermined moving schedule;
sending, by the central sever, a request for generating light or sound to the golf cart monitoring module at least when the corresponding operating golf cart moves slower than the predetermined moving schedule for generating signal light or reminder sound via light and/or sound generator, wherein the reminder sound is pre-recorded in an audio file stored in the storage of the golf cart monitoring module.

Preferably, when the golf cart is determined as moving slower than the predetermined moving schedule,
the golf cart monitoring module will generate a warning with a signal light for reminding the golfers regarding to a violation beyond the scheduled time,
if the golfer continues to violate then the golf cart monitoring module will generate a warning with an audio for reminding the golfers regarding to the continuing violation,
if the golfers ignore one or several warnings with the signal light or the audio, and continue to violate, violation report will be created and sent to the golf course management terminal devices.

According to an embodiment, the status of the golf holes capable to determine based on the locations of the operating golf carts on the map, if a golf hole is without a presence of any operating golf cart being at the location of said golf hole then the golf hole is considered as an available golf hole, if a golf hole is with a presence of an operating golf cart being at the location of said golf hole then the golf hole is considered as a busy golf hole,
wherein an estimated time duration for each busy golf hole becomes an available golf hole and each available golf hole becomes a busy golf hole are capable to determine based on the predetermined moving schedule of the operating golf cart being at the location of said golf hole or be going to move to the location of said golf hole,
based on the status of golf holes, the assignment of the golf hole for new players on the golf course is capable to perform via the golf course management terminal devices.

Preferably, said map further displaying non-operating golf carts which is assigned to a fourth color, corresponding to the golf carts in the status that not assign for players to use, based on the non-operating golf cart information, the assignment of the golf cart for new players on the golf course is capable to perform via the golf course management terminal devices.

According to an embodiment, the first color is green, the second color is yellow, the third color is red, and the fourth color is grey.

According to an embodiment, the above mentioned method further including sending, by the caddie terminal devices which are capable of accessing and transceiving data with the central sever, at least the confirmation information of the golf cart start operation, the confirmation information of the golf cart stop operation, and the additional services information, the foods ordering information, or the same information to the central sever.

According to an embodiment, the above mentioned method further including accessing, by user terminal devices, to the central sever for booking a game, seeing information related to the golf course, or the same information.

According to an embodiment, the central sever further configured to score the golfers by comparing the moving time of the corresponding golf cart to the predetermined moving schedule, and plus the accumulative scores for golfers who have the corresponding golf carts moving faster than the predetermined moving schedule.

Preferably, the central sever utilizing the operating time history of the golf cart, when the planning time period is passed, a message will be sent automatically to the terminal device of the golf cart managing staff, for reminding a periodical maintenance schedule.

Preferably, the central sever utilizing the operating time history and the operating status of the golf cart battery, for sending a message to the corresponding staff, suggesting for a maintenance or an error correction, or replacing a new golf cart battery.

Preferably, the golf cart monitoring module capable of using electric power source supplied from the golf cart battery and integrated to a golf cart battery unit for facilitating during an installation or a replacement.

### BRIEF DESCRIPTION OF THE DRAWINGS

FIG. 1 is a diagram illustrating a system for golf course management according to preferred embodiment of the present invention.

### DESCRIPTION OF EMBODIMENTS

Hereinafter, advantages, efficiencies, and inventive concepts of the present invention shall be understood more clearly through the detailed description of the preferred embodiments with reference to the accompanying drawings. However, it is understood that those preferred embodiments are mainly intended for illustrating and descriptive purposes for a person skilled in the art to which the present disclosure pertains, to fully understand the inventive concepts and the advantages of the present invention without any limitation the scope of the present invention to the following described embodiments.

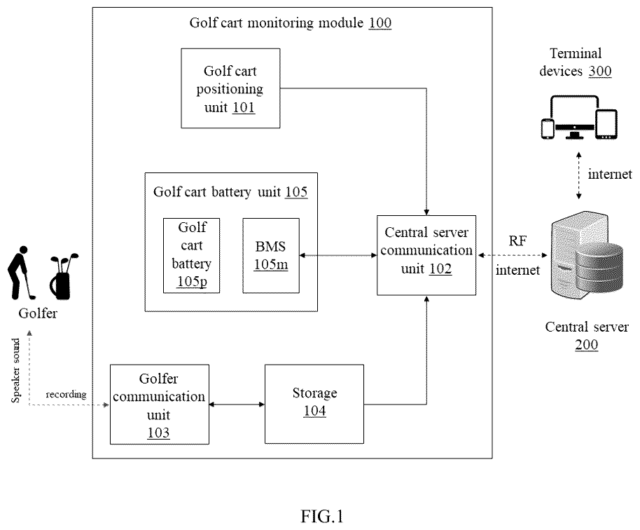

FIG. 1 is a diagram illustrating the system for golf course management according to preferred embodiment of the present invention.

As shown in FIG. 1, the system for golf course management according to the embodiment comprising substantially: a golf cart monitoring module 100, a central sever 200, and terminal devices 300.

The central sever 200 for storing and processing data corresponding to operations of the golf course, the central sever 200 allowing the terminal devices 300 that capable of accessing and transceiving data with the central sever 200, so that users may conveniently perform several functions on the terminal devices 300, such as allowing players to book a game; allowing the marshal of the golf course to assign the golf cart, assign the hole; allowing a caddie to confirm the beginning and the finishing of the golf playing round, supporting the golfers to order foods, additional services; and several different functions which are described in details hereafter.

The golf cart monitoring module 100 is disposed on each golf cart for collecting the golf cart location data which is related to the real time location of the corresponding golf cart and the battery data which is related to the operating status of a golf cart battery 105b, for sending the golf cart location data and the battery data to the central sever 200.

According to the embodiment, the golf cart monitoring module 100 including a golf cart positioning unit 101, a central sever communication unit 102, a golfer communication unit 103, a control and golf cart battery protection unit (BMS pin) 105m, and a storage 104.

The golf cart positioning unit 101 for determining the real time location of the corresponding golf cart via GPS. The golf cart positioning unit 101 may use an GPS antenna which is connected extending to an appropriate position on the golf cart. In general, the positioning technique via GPS is prior known, the present invention may apply any positioning technique without any particular limitation, for example positioning via satellite, positioning via radio, or the same.

The control and golf cart battery protection unit 105m for controlling and determining the operating status of the golf cart battery 105b. The golf cart battery 105b and the control and golf cart battery protection unit 105m are main components of the golf cart battery unit 105, ensuring to provide the power source stably for the operation of the golf cart. The golf cart is supposed/considered as a vehicle which has an important role for the movement of the golfers during a game/match, due to they have to move along a relatively far distance to finish a golf playing round. If the golf cart has a problem, mostly caused by errors of the golf cart battery, would make a significant inconvenience for the golfers.

On the other hand, the golf cart battery often utilizes lithium or LFP pins/batteries with the voltage of 52,3V or 72V, relatively high capacity, for example 80Ah, 100Ah, 150Ah, or 200Ah, usually requiring a substantial investment due to the need of the replacement after a usage period. If the lifetime of the battery is shorter the cost is higher. Therefore, utilizing the control and golf cart battery protection unit 105m having a significant role for enhancing the usability of the golf cart battery efficiently, and may reduce the cost and favorably prevent said inconvenience for the golfers, minimizing problems in which the golf cart is unmovable due to an error of pin/battery.

In general, the main function of the control and golf cart battery protection unit or may be called as BMS (Battery Management System) is to prevent the battery from over charging, protecting the battery from overload, balancing between battery cells, controlling charging and discharging processes, etc., so that preventing errors during the charging process or the operating process, and may extend the lifetime of the battery significantly. The BMS is well-known in the art which the present invention pertains, further details descriptions are intended to omit to concentrate to other characteristics of the present invention.

Preferably, the central sever 200 may utilize the operating time history of the golf cart, when the planning time period is passed, a message will be sent automatically to the terminal device of the golf cart managing staff, for reminding a periodical maintenance schedule. The central sever 200 may also utilize the operating time history and the operating status of the golf cart battery, for sending a message to the corresponding staff, suggesting for a maintenance or an error correction, or replacing a new golf cart battery.

The central sever communication unit 102 for communicating with the central sever 200 via the radio communication. Preferably, the central sever communication unit 102 utilize a SIM module having a slot for a 3G/4G/5G SIM card or the same to allow a communication with the central sever 200 via available services of the network provider. By utilizing the SIM module, the central sever 200 capable to receiving the data which transmits from the central sever communication unit 102 at a long distance, and the central sever 200 capable to send data, control commands to the golf cart monitoring module 100 via the central sever communication unit 102 by, for example SMS messages, OTA (Over-the-air) commands, or the same quickly and reliably. Herein, the radio communication is not limited to any known radio communication technique, such as the radio communication may be a communication using mobile networks, a communication using satellite services, or via the internet by data services of the 3G/4G/5G SIM, for example.

The storage 104 for storing at least pre-recorded audio files. The golfer communication unit 103 including at least light and/or sound generator for generating light or sound from the pre-recorded audio files stored in the storage 104 whenever there is a request for generating light or sound sent from the central sever 200.

According to preferred embodiment, the light and/or sound generator may use a speaker, and the golfer communication unit 103 may further include an audio recorder, for example a: microphone for recording commands, information, or verbal comments/reflections of people surrounding the location of the golf cart, to the central sever 200, such as the golfers or the caddies. The storage 104 may temporarily store those recorded audio files, or the current location of the golf cart prior to send to the central sever 200, or may be in a situation in which the network is in an error unable to send, to prevent the information are interrupted, for example. However, the present invention is not limited thereto, for sending requests, information, or verbal comments/reflections of people surrounding the location of the golf cart to the central sever 200, capable to perform via other channels, and therefore the audio recorder may be omitted.

According to preferred embodiment, the golf cart monitoring module 100 capable of using electric power source supplied from the golf cart battery 105b and integrated to a golf cart battery unit 105 for facilitating during an installation or a replacement. It is noticeable, according to the embodiment, the golf cart monitoring module 100 not only provides an easy method to determine the real time location of the golf carts and create a clear information channel between the golf cart and the operating center, this is an important factor for automatizing the profession of the golf course management, to which the combination with the battery control and the battery protection unit may provide the ability for the management which is much more efficiently and comprehensively. The golf cart monitoring module 100 may not only operate reliably by supplying a power source stably from the golf cart battery, but also be made compact and significant cost saving due to the usage of battery equipped for its own may be omitted. The battery unit 105 may utilize the common communication of the golf cart monitoring module for sending information related to the status of battery to the operating center, to be able to remotely intervene or repair on time, preventing risks which cause failures making the golf cart unmovable.

Obviously, alternative embodiments may be applied for the present invention. According to an exemplarily example, the golf cart monitoring module may be provided individually from the battery unit, wherein the golf cart monitoring module may not include a battery control and protection unit, and may optionally be supplied a power source from a battery separately equipped for its own, or supplied a power source from the golf cart battery. According to another exemplarily example, the golf cart monitoring module may include a battery control and protection unit, and placed far from the golf cart battery. However, the present invention is not limited thereto.

According to preferred embodiment, the terminal devices 300 may be any one of electronic devices, for example a smartphone, a tablet, a computer, a laptop, personal portable electronic devices, or the same electronic devices, utilized by the marshal(s) of the golf course (Marshal), the caddie(s) of the golfers (Caddie), the golfers, the golf course agencies, the golf course receptionists, the golf course accountants, or anyone of people who relate to the profession of the golf course as long as they are permitted or authorized to use. The terminal devices 300 capable of accessing and transceiving data with the central sever, for example via the internet, wired communications or wireless communications.

The golf course management terminal devices, are the terminal devices utilized by the marshal of the golf course, capable of accessing and transceiving data with the central sever for receiving at least the golf cart location data of the operating golf carts which are in the status of using for carrying the golfers, and utilizing the operating golf cart locations to draw a map which includes at least the operating golf carts for displaying to the marshal. The golf course management terminal devices may be installed an app called as GAS (Golf App Software) with a friendly user interface for supporting the marshal of the golf course capable to make an operation instantly. In general, the GAS may be customized differently, as long as it can display a map of the golf course with the golf carts to the marshal of the golf course and supporting users interact with the central sever and may be other terminal devices due to the permission or authorization of use.

It is noticeable, by collecting continuously the real time locations of each golf cart and drawing the map, capable to determine the real time movement precisely and the entire of movement of the golf carts.

According to the embodiment, the operating golf carts displayed on the map will be assigned the first, second, or third colors due to the corresponding actual moving status of each golf cart to the predetermined moving schedule of the golf cart. The operating golf cart displayed on the map is assigned to the first color if the corresponding golf cart moves faster than the predetermined moving schedule. The operating golf cart displayed on the map is assigned to the second color if the corresponding golf cart moves as appropriate as the predetermined moving schedule. Operating golf cart displayed on the map is assigned to the third color if the corresponding golf cart moves slower than the predetermined moving schedule.

The detail level of the displayed information on the map may be customized, or selected according to the golf course or a particular app. Such as, when the operating golf cart is displayed on the map it will be clearly indicated that the golf cart has finished how many golf holes and the current total of the playing time is faster or slower in minutes than the scheduling time ruled by the golf course. The map may display simplified or detail information to the user capable to know the information of the golf cart, for example the golf cart number 90 is at the golf hole number 8 and is slower 16 minutes than the scheduling time.

In general, to determine an operating golf cart is normal, fast or slow may be performed for each golf hole and along the entire of the match. However, the present invention is not limited thereto.

The central sever 200 sends a request for generating light or sound to the golf cart monitoring module 100 whenever the corresponding operating golf cart is determined as moving slower than the predetermined moving schedule for generating signal light or reminder sound via light and/or sound generator, wherein the reminder sound may be pre-recorded in an audio file stored in the storage of the golf cart monitoring module. Such as, a verbal warning may be “please move to the next hole”, for example. The reminder is capable to perform via a signal light device mounted on the golf cart, such as said light device is turned on to flash continuously, for example.

In general, if a certain golf cart is determined as moving slow, the golfers utilizing said golf cart are also determined as playing slow. An instant reminder may make them raise the consciousness to finish the current golf hole.

According to preferred embodiment, if a golf cart is determined as moving slower than the predetermined moving schedule, the golf cart monitoring module will generate a warning, firstly by a signal light for reminding the golfers regarding to the violation beyond the scheduled time. The signal light may be generated from a light device mounted on a rear/tail portion of the golf cart. However, the present invention is not limited thereto.

In reality, there may occur the situation in which golfers continue to violate, may be they did not notice or probably they intend to prolong to finish the current golf hole. The golf cart monitoring module will generate a warning with an audio for reminding the golfers regarding to the continuing violation. If the golfers continue to ignore the sound warning, and continue to violate, a violation report (may attach with the information of the beyond time) will be created and sent to the golf course management terminal devices/the marshal of the golf course to know and promptly take appropriate action.

However, the present invention is not limited thereto, any one of the warning or acting regulations may be set up according to each golf course. For example, the reminder may only utilize a light device, only utilize sound, utilize both light and sound in combination, or sequentially utilize signal light and/or sound according to a certain order, if the golfers ignore one or several of the warnings with the signal light or the audio, and continue to violate, a violation report will be created and sent to the golf course management terminal devices. In addition, the present invention may also include an embodiment in which all the warnings will be sent to the marshal, or when a violating time goes beyond a certain period, a report with information of the beyond time may be sent to the marshal of the golf course.

Optionally, in several cases the golf cart monitoring module or the central sever may send SMS messages to the marshal of the golf course when the golfers violate the playing time, or intend to violate.

To facilitate for the management operations, the golf cart monitoring module is configured to allow the golf course management terminal devices capable to communicate to the golf cart monitoring module, directly or via the central sever. This may support the manager interact quickly and directly with a golf playing group and a caddie in some certain situations.

According to an exemplarily example, the golf cart is determined as moving slower than the predetermined moving schedule if the golf cart, as for any reason (not yet finishing the golf hole or already finished but do not want to move, for example), not to move to the next hole after the period of time according to the moving schedule passed and it is over a predetermined period of time, for example 20s. Similarly, the golf cart is determined as moves faster than the predetermined moving schedule if the golf cart moves to the next hole when not yet finishing a period of time according to the moving schedule and remaining a predetermined period of time, for example 20s. In the remaining situations, the golf cart is determined as moving on time according to the predetermined moving schedule.

The generation of the reminder sound is capable to perform via light and/or sound generator such as a speaker mounted on the golf cart, however sometimes the golfers may be in a far distance from the golf cart making it difficult to hear the reminder sound, the marshal of the golf course may send the additional information to the caddie. By that way, the caddie may utilize a caddie terminal device to receive the additional information sent from the marshal via the golf course management terminal devices. The golf course management terminal devices and the caddie terminal devices capable to communicate to each other via the central sever, or communicate directly to each other. The caddie terminal devices may be installed an above mentioned GAS, and may be authorized differently from a GAS installed on the golf course management terminal devices.

Substantially, the status of the golf holes capable to determine based on the locations of the operating golf carts on the map, if a golf hole is without a presence of any operating golf cart being at the location of said golf hole then the golf hole is considered as an available golf hole, if a golf hole is with a presence of an operating golf cart being at the location of said golf hole then the golf hole is considered as a busy golf hole. An estimated time duration for each busy golf hole becomes an available golf hole and each available golf hole becomes a busy golf hole are capable to determine based on the predetermined moving schedule of the operating golf cart being at the location of said golf hole or be going to move to the location of said golf hole. Based on the status of golf holes, the assignment of the golf hole for new players on the golf course is capable to perform via the golf course management terminal devices.

While the golf course is open for the golfers, the golfer groups are preferably start at the first golf hole and finish a playing round at the last golf hole, such as the eighteenth golf hole, for example. However, if there are too many groups of the golfers to play, or there is a professional league, it is impossible for all of the playing groups start at the location of the first golf hole, because they will have to wait for the other groups for a long time. Therefore, the arrangement for one or more of the playing groups starting at any one of the golf holes may be applied, this actually reduces the waiting time of the golfers, increases the number of the playing groups simultaneously play on the golf course, and therefore enhancing management efficiency and revenue for the golf course.

The moving schedule of each golf cart is capable to be pre-determined by the starting movement time of the golf cart, the finishing time giving back the golf cart to the parking area, and the standard golf playing periods for each golf hole. The standard golf playing period for each golf hole may be dependent to the topographic type at said hole location, the number of the standard strokes (for example, 3 strokes-Par 3, 4 strokes-Par 4, or 5 strokes-Par 5), and defined specifically by the representative or the manager of the golf course, said information will be stored at the central sever 200 for a reference use. As for more convenient to define the pre-determined schedule of the golf cart, the caddie terminal devices, used by the caddie, capable of accessing and transceiving data with the central sever 200, for sending the confirmation information of the golf cart start operation, confirmation information of the golf cart stop operation.

In addition, the caddie terminal devices may also be used for sending additional services information, foods ordering information, or the same information to the central sever 200 according to a request of the golfers. The caddie terminal devices may also be used for sending a request to the marshal of the golf course via the marshal terminal devices, for example a request for the marshal to input a command to grant a moving permission, starting to play, getting foods, or the same. A sent information may be “please performing the ticket number x”, for example.

According to preferred embodiment, said map further displaying non-operating golf carts which is assigned to the fourth color, which corresponding to the golf carts in the status that not assign for players to use, based on the non-operating golf cart information, the assignment of the golf cart for new players on the golf course is capable to perform via the golf course management terminal devices.

Preferably, the first color is green, the second color is yellow, the third color is red, and the fourth color is grey. To display according to the different colors on the map providing visual images for the marshal of the golf course quickly and easily determining if there is any problem, and therefore capable to provide precise operations in a very short time.

According to preferred embodiment, the central sever 200 further configured to score the golfers by comparing the moving time of the corresponding golf cart to the predetermined moving schedule, and plus the accumulative scores for golfers who have the corresponding golf carts moving faster than the predetermined moving schedule.

In some cases, the group of golfers too slowly, may get warning reminder, minus scores, and in repeat situations, may lead to the marshal of the golf course giving a notice to stop a game. However, there may happen a situation wherein a group of golfers is allowed to play slowly, for example pay for a service to be played slowly or any specific reason, the subtraction of the score or tracking the movement of those group is unnecessary. The GAS in the golf course management terminal device may allow turn off the monitoring mode, scoring mode, or the same corresponding to said golf carts.

According to the present invention, plurality of apps or software modules, or software are authorized may be provided corresponding to multiple objects related to the profession of the golf course and customers, for example the marshal of the golf course (Marshal), a caddie of the golf course (Caddie), the golfers, the golf course agencies, the golf course receptionists, the golf course accountants.

Such as, a software called as GMS (Golf Course Management Software), may be installed in the server system or the central sever of the golf course, said GMS will automatically manage, control and interact with other terminal devices via the internet, for example a terminal device is used at the booking portion, the receptionist portion, the starting portion, the marshals, the caddies, the golf carts, the golf cart technicians, the customers and other objects related to the profession of the golf course. The GMS may store all of the information on golf course, the schedule, time and parking spots/stops of the golf carts, the moving time to finish one golf playing round.

The software called as WGS (Web Golf Software), may be installed in a desktop computer, a laptop via a website interface, supporting for the booking portion, the receptionist, or the playing club.

The software called as BAS (Booking App Software), may be installed in a smartphone, supporting for the golfer and the agencies to book a game directly on the server system of the golf course.

It should be understood that, the present invention is not limited to the software provided herein. In addition, the server may include software similar to the terminal devices to be used by users who are authorized.

In general, the software is created to comply with rules, such as the representative of the marshals has full rights to set up a list of staffs who interact with the software through an account and a password. Due to each positon, there may have rights such as: delete/edit right on the booking ticket, right for seeing without delete on the booking ticket; create/delete/edit right on the command for starting to the tee box, only seeing, partially edit; delete right, edit, adding, eliminating staff; right for seeing the statistic report, the moving history and the parking spots of the golf carts, list and information of the golfers by the real time, for example.

In an exemplarily example, a software kit is built for comprehensively automatizing the professions of the golf course may comprising: a GMS (Golf Course Management Software) system is installed in the server, a GAS (Golf App Software) authorized for used by the marshal of the golf course, a GAS is authorized for used by the caddie, a GAS authorized for used by the starting portion (Starter), a CGS (Computer Golf Software) used by the receptionist and the restaurant, a BAS (Booking App Software) used by the golfers and agencies.

The software kit may be linked together (due to particular requirements), and linked to the GMS system in the server via the internet. The operations of them in combination with the operations of the golf cart monitoring module for collecting the information from the corresponding golf carts communicated and linked to the server via the internet or radio, substantially providing a process for management which is comprehensively automatic with the efficiency is significantly improved for the profession of the golf course.

As easy and convenient for further understanding, one specific process of the marshal operation will be described as a reference. It should be understood that the present invention is not limited to the described operational process.

At the first step, a customer (a golfer or a golf course agencies) calls by a phone, sends an email, or uses an app on a mobile phone for booking a game with a playtime, the server system will send a SMS message whether the booking is successful or not.

Accepting a booking: opening a booking form on the app or on the computer for checking booking information, replying or clicking “Accept” on the booking form, the server system will send a SMS messages confirming the booking successful.

At the next step, the golfers go to the golf course, meeting with the receptionist providing the information about their name, the booking playtime. The receptionist checks the booking code on server system via a computer or an app, if it is correct then a ticket for playing a game (called as the tee off ticket, or a ticket) is opened, and providing a playing card, the locker key for the golfer and save the corresponding information onto the ticket. The server system will send a vocal message to the app of the starting portion, for example “Please serving the ticket number . . . ”.

At the next step, the starting portion open the ticket, selecting a golf cart and a caddie in the list available in the server system, there is substantially only the golf carts and the caddies not yet assigned to golfers are shown on the list. The server system will send a vocal message to the app of the marshal of the golf course, for example “Please serving the ticket number . . . ”

At the next step, the marshal of the golf course will open the map of the golf course seeing available holes for assigning a hole to start a playing round, open the ticket to assign the hole respectively. The marshal of the golf course has a right to check and replace the caddie, the golfers, selecting for a hole to start on the ticket. The server system will send a vocal message to the app on the terminal device of the caddie, for example “Please moving to the next hole . . . ”.

At the next step, the caddie opens the ticket, checking the information and guiding for the golfers moving to the tee box to start.

The golfer and the caddie wait for their starting turn, open the ticket on the app and press the starting button.

The caddie opens the menu button on the ticket (if the golfer has a request for foods), selecting the golfer who said caddie serves, selecting foods, quantity, clicking to order. The server system informs a verbal message to the app of the restaurant. The restaurant receives the golfer information, the caddie, the golf course number, the current location and the list of foods to prepare, after that coming and giving them to the golfer as required.

At that time, the system for golf course management switches to automatic mode which automatically tracks, monitors, warns and reminds (if the golfers play slower than the scheduling time for each hole). The golf cart which moves faster than the scheduling time having a corresponding icon on the map is green, the golf cart which moves on time by the scheduling time having a corresponding icon on the map is yellow, the golf cart which moves slower than the scheduling time having a corresponding icon on the map is with light (for example a LED signal light) at a rear portion of the golf cart automatically turned on. If the golfer is continuously slow, the speaker of the golf cart monitoring module will generate an audio segment “You are playing slow . . . minutes, please speed up the game”. If it is continuously further slow, the system will message to the marshal of the golf course, for example “The golf cart number . . . moving slowly at the hole . . . ”, for an instant handling measures.

At the next step, the marshal of the golf course opens the map on the app, tracking, monitoring, managing the caddie, etc., opens a tee off ticket to turn On/Off the mode for warning, reminder for any golf cart.

At the next step, the caddie opens the tee off ticket to press the finishing button (when the golf cart has returned to the parking zone), or request for continuing to play.

When receiving the request for continuing to play from the caddie, the marshal opens the ticket, making a confirmation for the golfers (open the tee off ticket, pressing on “continue playing”, selecting hole for tee off to continue playing, the process will happen sequentially again similar to those described above. If the golfer finish playing, the caddie drives the golf cart to the parking zone, opens the app and press finishing to return the golf cart, other items.

At the next step, the receptionist gets back the playing card, the locker key, checks the tee off ticket again, checks foods order, and charges for the golfers.

And finally, after a planning time period and/or the golf cart runs enough the number of kilometers as prescribed then the system will message to the phone of the marshal of the golf cart, for example “the golf cart number . . . due time for maintenance”.

According to another aspect of the present invention, the method for golf course management according to preferred embodiment of the present invention, substantially includes characteristics equivalent to the system for golf course management as described above.

In general, the method for golf course management comprising the steps of:
storing and processing, by the central sever, data corresponding to operations of the golf course, wherein the central sever allowing terminal devices capable of accessing and transceiving data with the central sever;
collecting, by the golf cart monitoring module disposed on each golf cart, at least the golf cart location data which is related to the real time location of the corresponding golf cart and the battery data which is related to the operating status of the golf cart battery, and sending the golf cart location data and the battery data to the central sever;
wherein:
the golf cart monitoring module including a golf cart positioning unit, a central sever communication unit, a golfer communication unit, a control and golf cart battery protection unit, and a storage,
the golf cart positioning unit for determining the real time location of the corresponding golf cart via GPS,
the control and golf cart battery protection unit for controlling and determining the operating status of the golf cart battery,
the central sever communication unit for communicating with the central sever via the radio communication,
the storage for storing at least pre-recorded audio files,
the golfer communication unit including at least light and/or sound generator for generating light or sound from pre-recorded audio files stored in the storage whenever there is a request for generating light or sound sent from the central sever;
receiving, by the golf course management terminal devices which are capable of accessing and transceiving data with the central sever, at least the golf cart location data of the operating golf carts which are in the status of using for carrying the golfers, and utilizing the operating golf cart locations to draw a map which includes at least the operating golf carts for displaying to the marshal,
wherein, the operating golf carts displayed on the map will be assigned the first, second, or third colors due to the corresponding actual moving status of each golf cart to the predetermined moving schedule of the golf cart,
operating golf cart displayed on the map is assigned to a first color if the corresponding golf cart moves faster than the predetermined moving schedule,
operating golf cart displayed on the map is assigned to a second color if the corresponding golf cart moves as appropriate as the predetermined moving schedule,
operating golf cart displayed on the map is assigned to a third color if the corresponding golf cart moves slower than the predetermined moving schedule;
   sending, by the central sever, a request for generating light or sound to the golf cart monitoring module at least when the corresponding operating golf cart moves slower than the predetermined moving schedule for generating signal light or reminder sound via light and/or sound generator, wherein the reminder sound is pre-recorded in an audio file stored in the storage of the golf cart monitoring module.

Although some embodiments have been described herein. It should be understood that obvious modifications, equivalent arrangements, or variations could be made based on the described embodiments by an ordinary skill in the art. Therefore, all these modifications, equivalents, or variations fall within the protection scope of the claims appended.

1. A system for golf course management comprising:
a central sever for storing and processing data corresponding to operations of the golf course, the central sever allowing terminal devices capable of accessing and transceiving data with the central sever;
a golf cart monitoring module is disposed on each golf cart for collecting at least the golf cart location data which is related to the real time location of the corresponding golf cart and the battery data which is related to the operating status of the golf cart battery, for sending the golf cart location data and the battery data to the central sever;
wherein:
the golf cart monitoring module including a golf cart positioning unit, a central sever communication unit, a golfer communication unit, a control and golf cart battery protection unit, and a storage,
the golf cart positioning unit for determining the real time location of the corresponding golf cart via GPS,
the control and golf cart battery protection unit for controlling and determining the operating status of the golf cart battery,
the central sever communication unit for communicating with the central sever via the radio communication,
the storage for storing at least pre-recorded audio files, temporarily storing data sending/receiving to/from the central sever if the golf cart moving within a region with weak 3G/4G signals,
the golfer communication unit including at least a light and/or sound generator for generating light or sound from the pre-recorded audio files stored in the storage whenever there is a request for generating light or sound sent from the central sever;
golf course management terminal devices are capable of accessing and transceiving data to the central sever for receiving at least the golf cart location data among the operating golf carts which are in the status of use for carrying the golfers, and utilizing the operating golf cart locations to draw a map which includes at least the operating golf carts for displaying to the marshal,
wherein, the operating golf carts displayed on the map on the map will be assigned to the first, second, or third colors due to the corresponding actual moving status of each golf cart compared to the predetermined moving schedule of the golf cart,
an operating golf cart displayed on the map is assigned to a first color if the corresponding golf cart moves faster than the predetermined moving schedule,
an operating golf cart displayed on the map is assigned to a second color if the corresponding golf cart moves as appropriate as the predetermined moving schedule,
an operating golf cart displayed on the map is assigned to a third color if the corresponding golf cart moves slower than the predetermined moving schedule;
the central sever sending a request for generating light or sound to the golf cart monitoring module at least when the corresponding operating golf cart moves slower than the predetermined moving schedule for generating signal light or reminder sound via the light and/or sound generator, wherein the reminder sound is pre-recorded in an audio file stored in the storage of the golf cart monitoring module.

2. The system according to claim 1, wherein when the golf cart is determined as moving slower than the predetermined moving schedule,
the golf cart monitoring module will generate a warning with a signal light for reminding the golfers regarding to a violation beyond the scheduled time,
if the golfer continues to violate then the golf cart monitoring module will generate a warning with an audio for reminding the golfers regarding to the continuing violation,
if the golfers ignore one or several said warnings with the signal light or the audio, and continue to violate, a violation report will be created and sent to the golf course management terminal devices.

3. The system according to claim 1, wherein the golf cart monitoring module is configured to allow the golf course management terminal devices capable to communicate to the golf cart monitoring module, directly or via the central sever.

4. The system according to claim 1, wherein the status of the golf holes capable to determine based on the locations of the operating golf carts on the map, if a golf hole is without a presence of any operating golf cart being at the location of said golf hole then the golf hole is considered as an available golf hole, if a golf hole is with a presence of an operating golf cart being at the location of said golf hole then the golf hole is considered as a busy golf hole,
wherein an estimated time duration for each busy golf hole becomes an available golf hole and each available golf hole becomes a busy golf hole, is capable to determine based on the predetermined moving schedule of the operating golf cart being at the location of said golf hole or be going to move to the location of said golf hole,
based on the status of golf holes, the assignment of the golf hole for new players on the golf course is capable to perform via the golf course management terminal devices.

5. The system according to claim 1, wherein said map further displaying non-operating golf carts which is assigned to a fourth color, corresponding to the golf carts in the status that not assigning for players to use, based on the non-operating golf cart information, the assignment of the golf cart for new players on the golf course is capable to perform via the golf course management terminal devices.

6. The system according to claim 5, wherein the first color is green, the second color is yellow, the third color is red, and the fourth color is grey.

7. The system according to claim 1, wherein the system further including caddie terminal devices capable of accessing and transceiving data with the central sever for sending at least the confirmation information of the golf cart start operation, the confirmation information of the golf cart stop operation, and the additional services information, the foods ordering information, or the same information to the central sever.

8. The system according to claim 1, wherein the system further including user terminal devices capable of accessing with the central sever for booking a game, seeing information related to the golf course, or the same information.

9. The system according to claim 1, wherein the central sever further configured to score the golfers by comparing the moving time of the corresponding golf cart to the predetermined moving schedule, and plus the accumulative scores for golfers who have the corresponding golf carts moving faster than the predetermined moving schedule.

10. The system according to claim 1, wherein the central sever utilizing the operating time history of the golf cart, when the planning time period is passed, a message will be sent automatically to the terminal device of the golf cart managing staff, for reminding a periodical maintenance schedule.

11. The system according to claim 1, wherein the central sever utilizing the operating time history and the operating status of the golf cart battery, for sending a message to the corresponding staff, suggesting for a maintenance or an error correction, or replacing a new golf cart battery.

12. The system according to claim 1, wherein the golf cart monitoring module capable of using electric power source supplied from the golf cart battery and integrated to a golf cart battery unit for facilitating during an installation or a replacement.

13. A method for golf course management comprising the steps of:
storing and processing, by the central sever, data corresponding to operations of the golf course, wherein the central sever allowing terminal devices capable of accessing and transceiving data with the central sever;
collecting, by the golf cart monitoring module disposed on each golf cart, at least the golf cart location data which is related to the real time location of the corresponding golf cart and the battery data which is related to the operating status of the golf cart battery, and sending the golf cart location data and the battery data to the central sever;
wherein:
the golf cart monitoring module including a golf cart positioning unit, a central sever communication unit, a golfer communication unit, a control and golf cart battery protection unit, and a storage,
the golf cart positioning unit for determining the real time location of the corresponding golf cart via GPS,
the control and golf cart battery protection unit for controlling and determining the operating status of the golf cart battery,
the central sever communication unit for communicating with the central sever via the radio communication,
the storage for storing at least pre-recorded audio files,
the golfer communication unit including at least light and/or sound generator for generating light or sound from pre-recorded audio files stored in the storage whenever there is a request for generating light or sound sent from the central sever;
receiving, by the golf course management terminal devices which are capable of accessing and transceiving data with the central sever, at least the golf cart location data of the operating golf carts which are in the status of using for carrying the golfers, and utilizing the operating golf cart locations to draw a map which includes at least the operating golf carts for displaying to the marshal,
wherein, the operating golf carts displayed on the map will be assigned the first, second, or third colors due to the corresponding actual moving status of each golf cart to the predetermined moving schedule of the golf cart,
operating golf cart displayed on the map is assigned to a first color if the corresponding golf cart moves faster than the predetermined moving schedule,
operating golf cart displayed on the map is assigned to a second color if the corresponding golf cart moves as appropriate as the predetermined moving schedule,
operating golf cart displayed on the map is assigned to a third color if the corresponding golf cart moves slower than the predetermined moving schedule;
sending, by the central sever, a request for generating light or sound to the golf cart monitoring module at least when the corresponding operating golf cart moves slower than the predetermined moving schedule for generating signal light or reminder sound via light and/or sound generator, wherein the reminder sound is pre-recorded in an audio file stored in the storage of the golf cart monitoring module.

14. The method according to claim 13, wherein when the golf cart is determined as moving slower than the predetermined moving schedule,
the golf cart monitoring module will generate a warning with a signal light for reminding the golfers regarding to a violation beyond the scheduled time,
if the golfer continues to violate then the golf cart monitoring module will generate a warning with an audio for reminding the golfers regarding to the continuing violation,
if the golfers ignore one or several warnings with the signal light or the audio, and continue to violate, violation report will be created and sent to the golf course management terminal devices.

15. The method according to claim 13, wherein the golf cart monitoring module is configured to allow the golf course management terminal devices capable to communicate to the golf cart monitoring module, directly or via the central sever.

16. The method according to claim 13, wherein the status of the golf holes capable to determine based on the locations of the operating golf carts on the map, if a golf hole is without a presence of any operating golf cart being at the location of said golf hole then the golf hole is considered as an available golf hole, if a golf hole is with a presence of an operating golf cart being at the location of said golf hole then the golf hole is considered as a busy golf hole,
wherein an estimated time duration for each busy golf hole becomes an available golf hole and each available golf hole becomes a busy golf hole are capable to determine based on the predetermined moving schedule of the operating golf cart being at the location of said golf hole or be going to move to the location of said golf hole,
based on the status of golf holes, the assignment of the golf hole for new players on the golf course is capable to perform via the golf course management terminal devices.

17. The method according to claim 13, wherein said map further displaying non-operating golf carts which is assigned to a fourth color, corresponding to the golf carts in the status that not assign for players to use, based on the non-operating golf cart information, the assignment of the golf cart for new players on the golf course is capable to perform via the golf course management terminal devices.

18. The method according to claim 17, wherein the first color is green, the second color is yellow, the third color is red, and the fourth color is grey.

19. The method according to claim 13, wherein the method further including sending, by caddie terminal devices which are capable of accessing and transceiving data with the central sever, at least the confirmation information of the golf cart start operation, the confirmation information of the golf cart stop operation, and the additional services information, the foods ordering information, or the same information to the central sever.

20. The method according to claim 13, wherein the method further including accessing, by user terminal devices, to the central sever for booking a game, seeing information related to the golf course, or the same information.

21. The method according to claim 13, wherein the central sever further configured to score the golfers by comparing the moving time of the corresponding golf cart to the predetermined moving schedule, and plus the accumulative scores for golfers who have the corresponding golf carts moving faster than the predetermined moving schedule.

22. The method according to claim 13, wherein the central sever utilizing the operating time history of the golf cart, when the planning time period is passed, a message will be sent automatically to the terminal device of the golf cart managing staff, for reminding a periodical maintenance schedule.

23. The method according to claim 13, wherein the central sever utilizing the operating time history and the operating status of the golf cart battery, for sending a message to the corresponding staff, suggesting for a maintenance or an error correction, or replacing a new golf cart battery.

24. The method according to claim 13, wherein the golf cart monitoring module capable of using electric power source supplied from the golf cart battery and integrated to a golf cart battery unit for facilitating during an installation or a replacement.
